(19) United States
(12) Patent Application Publication
(10) Pub. No.: US 2009/0046480 A1
(43) Pub. Date: Feb. 19, 2009

(54) BACKLIGHT MODULE AND DISPLAY USING THE SAME

(75) Inventors: Chien-Hsiang Chen, Hsinchu (TW); Jui-Nien Jao, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANO PRECISION CORPORATION, Hsinchu (TW)

(21) Appl. No.: 12/025,781

(22) Filed: Feb. 5, 2008

(30) Foreign Application Priority Data
Aug. 16, 2007 (TW) 96130335

(51) Int. Cl. F21V 7/04

(52) U.S. Cl. 362/617

(57) ABSTRACT

A backlight module applied to a display and including a linear light source and a light guide plate (LGP) is provided. The LGP includes a light emitting surface, a bottom surface, a light incident surface, a first side surface, a second side surface and a microstructure. The bottom surface is opposite to the light emitting surface. The light incident surface is in contact with the light emitting surface and the bottom surface. The linear light source is disposed adjacent to the light incident surface. The first side surface is opposite to the light incident surface and in contact with the light emitting surface and the bottom surface. The second side surface is in contact with the light emitting surface, the bottom surface, the light incident surface and the first side surface. The microstructure is formed on the second side surface and adjacent to the light incident surface.

### CROSS-REFERENCE TO RELATED APPLICATION

This application claims the priority benefit of Taiwan application serial no. 96130335, filed on Aug. 16, 2007. The entirety of the above-mentioned patent application is hereby incorporated by reference herein and made a part of this specification.

### BACKGROUND OF THE INVENTION

1. Field of the Invention

The present invention relates to a backlight module (BLM) and particularly to a display using the same.

2. Description of Related Art

FIG. 1 illustrates a schematic side view of a conventional backlight module, and FIG. 2 illustrates a top view of the backlight module of FIG. 1. Referring to FIGS. 1 and 2, a conventional backlight module 100 includes a cold cathode fluorescent lamp (CCFL) 110 and a light guide plate (LGP) 120. The CCFL 110 is disposed adjacent to a light incident surface 122 of the LGP 120, and light provided by the CCFL 110 is capable of entering the LGP 120 from the light incident surface 122 and then transmitted out of the LGP 120 from a light emitting surface 124 of the LGP 120 so as to form a planar light source.

It should be noted that since two opposite ends of the CCFL 110 are non-illuminant electrode ends 112, when the backlight module 100 is operating, dark corners 126 are formed in places adjacent to the light incident surface 122 and corresponding to the electrode ends 112 on the LGP 120. As a result, the light uniformity of the planar light source is poor.

In order to solve the above-mentioned problem, the prior art usually extends a length of the CCFL 110 or adding light emitting diode (LED) light sources adjacent to the dark corners 126 to enhance the brightness of the dark corners 126. Nevertheless, extending the length of the CCFL 110 increases a whole volume of the backlight module 100 and adding the LED light sources consumes additional electricity.

### SUMMARY OF THE INVENTION

The present invention is directed to a backlight module and a display using the same so as to enhance light uniformity of a planar light source.

One embodiment of the present invention is directed to a backlight module applied in a display. The backlight module includes a first linear light source and a light guide plate (LGP). The LGP includes a light emitting surface, a bottom surface, a light incident surface, a first side surface, a second side surface and a first microstructure. The bottom surface is opposite to the light emitting surface, and the light incident surface is in contact with the light emitting surface and the bottom surface. The first linear light source is disposed adjacent to the light incident surface. The first side surface is opposite to the light incident surface and in contact with the light emitting surface and the bottom surface. The second side surface is in contact with the light emitting surface, the bottom surface, the light incident surface and the first side surface. The first microstructure is formed on the second side surface and adjacent to the light incident surface.

One embodiment of the present invention is further directed to a display including a display panel and the aforesaid backlight module. The backlight module is disposed on one side of the display panel to provide a planar light source required by the display panel, and the light emitting surface of the LGP of the backlight module faces the display panel.

In one embodiment of the present invention, the LGP has a microstructure on the side surface thereof adjacent to the light incident surface. Therefore, in comparison with the prior art, when the backlight module is operating, it is not likely to form dark corners on the side surface of the LGP adjacent to the light incident surface.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a schematic side view of a conventional backlight module.

FIG. 2 illustrates a top view of the backlight module of FIG. 1.

FIG. 3 illustrates a schematic side view of a display according to a first embodiment of the present invention.

FIG. 4 illustrates a schematic top view of a portion of components in a backlight module of FIG. 3.

FIG. 5 illustrates a schematic top view of a portion of components in a backlight module according to another embodiment of the present invention.

FIG. 6 illustrates a partially enlarged three-dimensional schematic view of an LGP according to another embodiment of the present invention.

FIG. 7 illustrates a schematic side view of a display according to a second embodiment of the present invention.

FIG. 8 illustrates a schematic top view of a portion of components of the backlight module of FIG. 7.

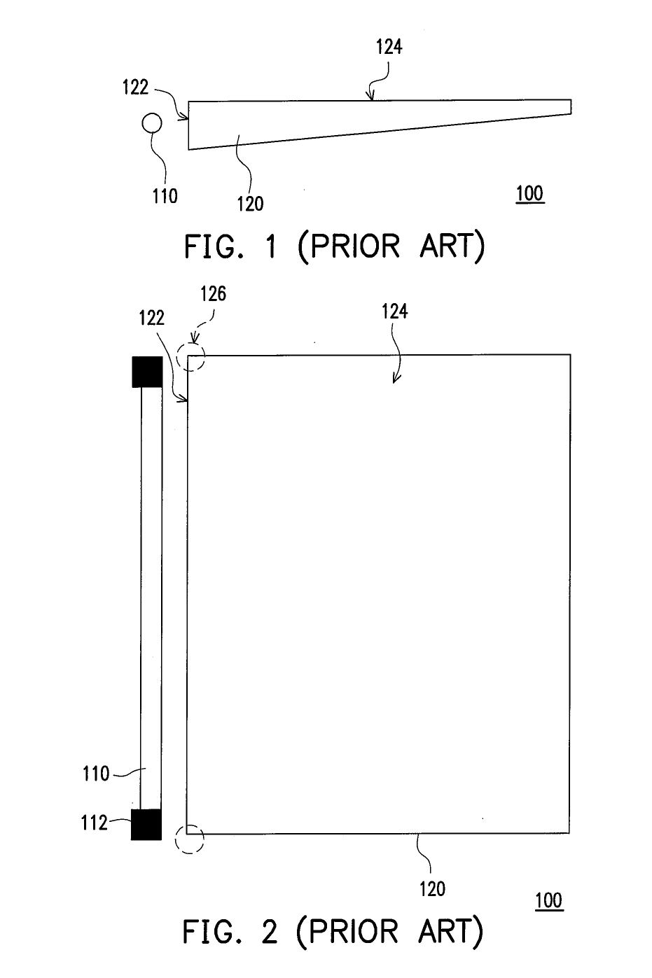

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### First Embodiment

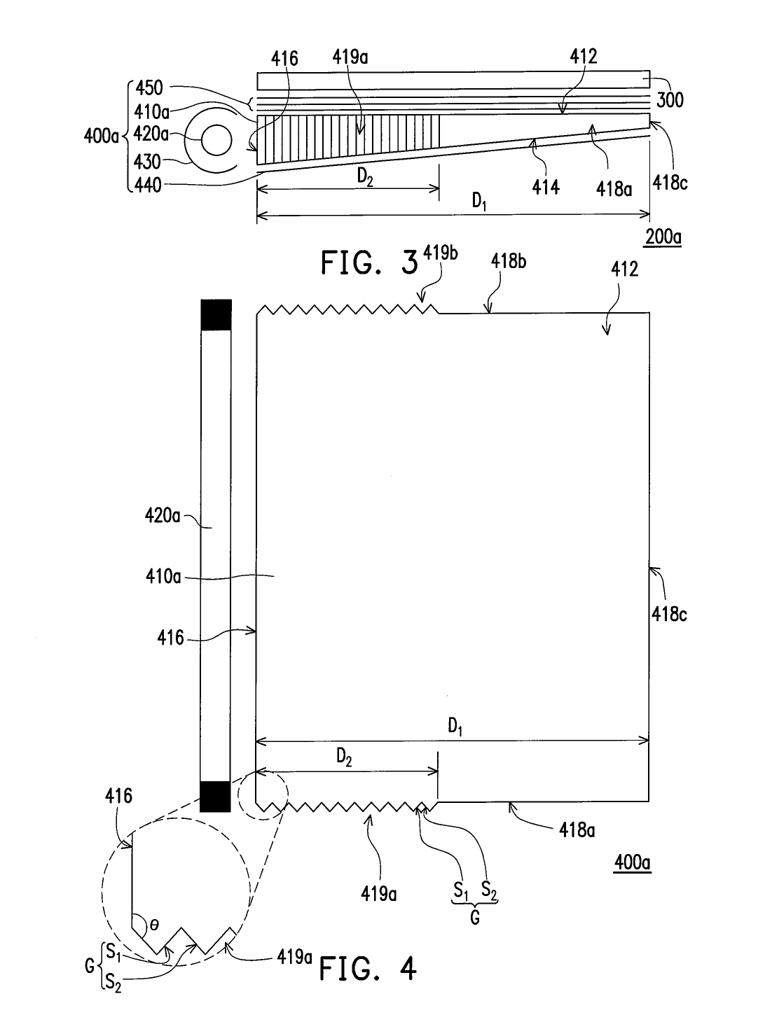

FIG. 3 illustrates a schematic side view of a display according to a first embodiment of the present invention, and FIG. 4 illustrates a schematic top view of a portion of components in the backlight module of FIG. 3. Referring to FIGS. 3 and 4, a display 200a, for example, a liquid crystal display (LCD) includes a display panel 300, for example, an LCD panel and a backlight module 400a. The backlight module 400a is, for example, a side edge type backlight module and disposed on one side of the display panel 300. The backlight module 400a includes a light guide plate (LGP) 410a and a linear light source 420a. The LGP 410a is a wedge type LGP, and the linear light source 420a is a cold cathode fluorescent lamp (CCFL), for example.

The LGP 410a has a light emitting surface 412, a bottom surface 414, a light incident surface 416, two opposite side surfaces 418a and 418b, a side surface 418c and two microstructures 419a and 419b. The light emitting surface 412 faces the display panel 300. The bottom surface 414 is opposite to the light emitting surface 412. The light incident surface 416 is in contact with the light emitting surface 412 and the bottom surface 414, and the linear light source 420a is disposed adjacent to the light incident surface 416. The side surface 418c is opposite to the light incident surface 416 and in contact with the light emitting surface 412 and the bottom surface 414. The side surfaces 418a and 418b are in contact with the light emitting surface 412, the bottom surface 414, the light incident surface 416 and the side surface 418c.

Furthermore, the microstructures 419a and 419b are formed on the side surfaces 418a and 418b respectively and adjacent to the light incident surface 416. Positions of the microstructures 419a and 419b correspond with each other and the two microstructures have identical configurations, for example. The microstructure 419a is illustrated in detail as an example in the following. In the first embodiment, the microstructure 419a includes a plurality of V-shaped grooves G. The grooves G extend from a place adjacent to the light emitting surface 412 to a place adjacent to the bottom surface 414 in a direction parallel to the light incident surface 416. Each of the grooves G includes a first slanted surface S₁ adjacent to the light incident surface 416 and a second slanted surface S₂ far away from the light incident surface 416. An included angle θ between the second slanted surface S₂ of each of the grooves G and the light incident surface 416 is larger than 90 degrees and smaller than or equal to 135 degrees, for example.

Moreover, a distribution range of the microstructure 419a takes up, for example, at least one-third of a length of the side surface 418a. More specifically, the light incident surface 416 of the LGP 410a is in a first distance D₁ from the side surface 418c, and a second distance D₂ is in the distribution range of the microstructure 419a in a direction parallel to the first distance D₁, for example. The second distance D₂ is at least one-third of the first distance D₁.

In view of the abovementioned, the LGP 410a has the microstructures 419a and 419b on the side surfaces 418a and 418b adjacent to the light incident surface 416. Therefore, when light provided by the linear light source 420a is transmitted into the LGP 410a from the light incident surface 416 and is transmitted to the microstructures 419a and 419b, a portion of the light is reflected by the microstructures 419a and 419b. As a result, the problem of the dark corners 126 (referring to FIG. 2) occurring in the prior art is mitigated.

It should be noted that since the present invention does not need to extend a length of the linear light source 420a, no additional light source is required and the problem of the dark corners 126 occurring in the prior art is mitigated. Hence, the present invention not only does not increase a whole volume of the backlight module 400a, but it also does not need to consume additional electricity.

In addition, referring to FIG. 3, the backlight module 400a further includes a reflective cover 430, a reflective sheet 440 and an optical film set 450. The reflective cover 430 is disposed adjacent to the light incident surface 416, and the linear light source 420a is located between the light incident surface 416 and the reflective cover 430. The reflective sheet 440 is disposed on the bottom surface 414. The optical film set 450 is disposed on the light emitting surface 412 and located between the display panel 300 and the LGP 410a. The optical film set 450 includes at least one of a diffusion plate, a prism plate and a brightness-enhanced film (BEF).

The reflective cover 430 is used for reflecting light provided by the linear light source 420a to the light incident surface 416 so that the light is transmitted into the LGP 410a from the light incident surface 416. The reflective sheet 440 is used for reflecting the light transmitted into the LGP 410a to the light emitting surface 412 so that the light is transmitted out from the light emitting surface 412 and is formed as a planar light source required by the display panel 300. The optical film set 450 is used for homogenizing the planar light source transmitted out from the light emitting surface 412 and for enhancing the brightness of the planar light source.

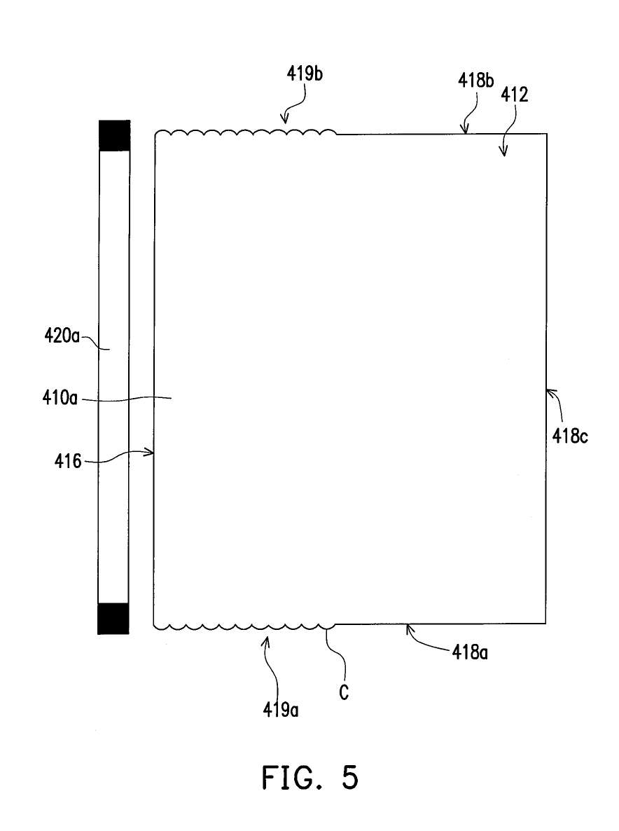

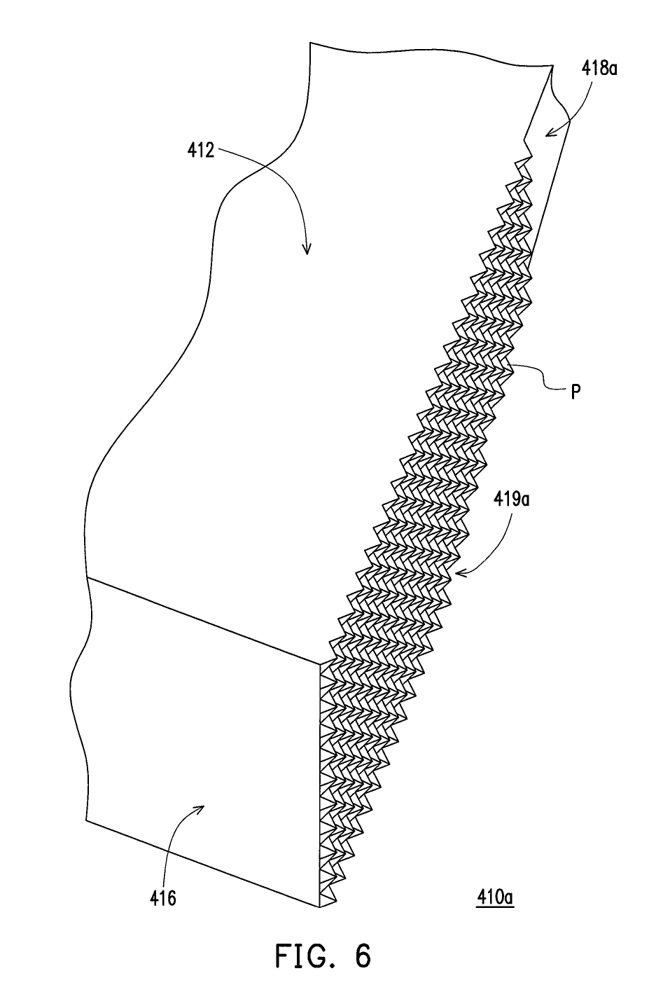

However, the present invention is not limited to the aforesaid embodiment. Referring to FIG. 5, it illustrates a schematic top view of a portion of components in a backlight module according to another embodiment of the present invention. According to the present embodiment, the microstructure 419a includes a plurality of cambered protrusions C, and the configuration and the position of the microstructure 419b correspond to those of the microstructure 419a. Referring to FIG. 6, it illustrates a partially enlarged three-dimensional schematic view of an LGP according to another embodiment of the present invention. According to the present embodiment, the microstructure 419a includes a plurality of pyramid-shaped protrusions P.

### Second Embodiment

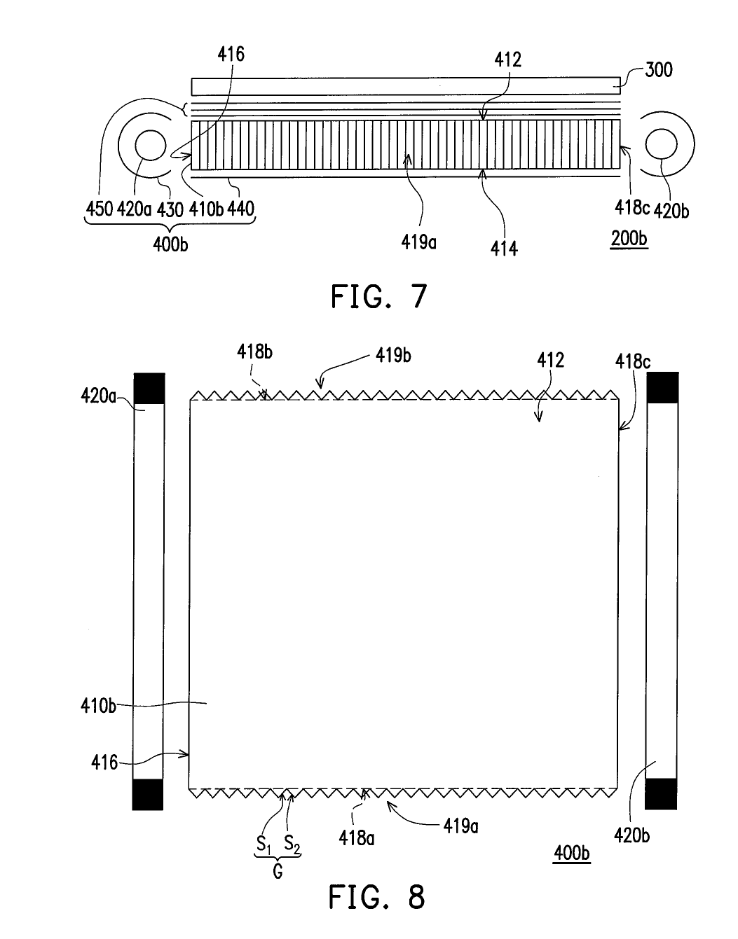

FIG. 7 illustrates a schematic side view of a display according to a second embodiment of the present invention, and FIG. 8 illustrates a schematic top view of a portion of components of a backlight module in FIG. 7. Referring to FIGS. 7 and 8, a structure of a display 200b in the second embodiment is similar to a structure of the display 200a as illustrated in FIGS. 3 and 4. Differences between the two displays lie in that a backlight module 400b of the display 200b further includes another linear light source 420b and that an LGP 410b is a flat type LGP, for example. Additionally, the microstructures 419a and 419b are distributed all over the side surfaces 418a and 418b of the LGP 410b. Further, the linear light source 420b is, for example, another CCFL disposed adjacent to the side surface 418c so that the side surface 418c is formed as another light incident surface.

According to the second embodiment, the microstructures 419a and 419b include a plurality of V-shaped grooves G. However, in other embodiments, the microstructures 419a and 419b may include a plurality of the cambered protrusions C as illustrated in FIG. 5 or the pyramid-shaped protrusions P as illustrated in FIG. 6.

In summary, the LGP has microstructures on the side surface thereof and adjacent to the light incident surface. Therefore, in comparison with the prior art, when the backlight module is operating, it is not likely to form dark corners on the side surface of the LGP adjacent to the light incident surface.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module applied to a display, comprising:
a first linear light source; and
a light guide plate, comprising:
a light emitting surface;
a bottom surface, opposite to the light emitting surface;
a light incident surface, in contact with the light emitting surface and the bottom surface, wherein the first linear light source is disposed adjacent to the light incident surface;
a first side surface, opposite to the light incident surface and in contact with the light emitting surface and the bottom surface;
a second side surface, in contact with the light emitting surface, the bottom surface, the light incident surface and the first side surface; and
a first microstructure, formed on the second side surface and adjacent to the light incident surface.

2. The backlight module as claimed in claim 1, wherein the light incident surface is in a first distance from the first side surface, a distribution range of the first microstructure is in a direction parallel to the first distance and has a second distance from the light incident surface, and the second distance is at least one-third of the first distance.

3. The backlight module as claimed in claim 1, wherein the first microstructure comprises a plurality of grooves, and each of the grooves extends from a place adjacent to the light emitting surface to a place adjacent to the bottom surface in a direction parallel to the light incident surface.

4. The backlight module as claimed in claim 3, wherein each of the grooves has a first slanted surface and a second slanted surface, the first slanted surface is adjacent to the light incident surface and the second slanted surface is far away from the light incident surface, and an included angle between the second slanted surface and the light incident surface is larger than 90 degrees and smaller than or equal to 135 degrees.

5. The backlight module as claimed in claim 1, wherein the first microstructure includes a plurality of pyramid-shaped protrusions or a plurality of cambered protrusions.

6. The backlight module as claimed in claim 1, wherein the light guide plate further comprises:
a third side surface, opposite to the second side surface and in contact with the light emitting surface, the bottom surface, the light incident surface and the first side surface; and
a second microstructure, formed on the third side surface and adjacent to the light incident surface.

7. The backlight module as claimed in claim 6, wherein a position of the second microstructure corresponds to a position of the first microstructure.

8. The backlight module as claimed in claim 6, wherein a configuration of the second microstructure is identical to a configuration of the first microstructure.

9. The backlight module as claimed in claim 1, further comprising a second linear light source disposed adjacent to the first side surface.

10. The backlight module as claimed in claim 1, wherein the light guide plate is a wedge type or a flat type light guide plate.

11. A display, comprising:
a display panel; and
a backlight module, disposed on one side of the display panel to provide a planar light source required by the display panel, wherein the backlight module comprises:
a first linear light source; and
a light guide plate, comprising:
a light emitting surface, facing the display panel;
a bottom surface, opposite to the light emitting surface;
a light incident surface, in contact with the light emitting surface and the bottom surface, wherein the first linear light source is disposed adjacent to the light incident surface;
a first side surface, opposite to the light incident surface and in contact with the light emitting surface and the bottom surface;
a second side surface, in contact with the light emitting surface, the bottom surface, the light incident surface and the first side surface; and
a first microstructure, formed on the second side surface and adjacent to the light incident surface.

12. The display as claimed in claim 11, wherein the light incident surface is in a first distance from the first side surface, a distribution range of the first microstructure in a direction parallel to the first distance and has a second distance from the light incident surface, and the second distance is at least one-third of the first distance.

13. The display as claimed in claim 11, wherein the first microstructure comprises a plurality of grooves, and each of the grooves extends from a place adjacent to the light emitting surface to a place adjacent to the bottom surface in a direction parallel to the light incident surface.

14. The display as claimed in claim 13, wherein each of the grooves has a first slanted surface and a second slanted surface, the first slanted surface is adjacent to the light incident surface and the second slanted surface is far away from the light incident surface, and an included angle between the second slanted surface and the light incident surface is larger than 90 degrees and smaller than or equal to 135 degrees.

15. The display as claimed in claim 11, wherein the first microstructure comprises a plurality of pyramid-shaped protrusions or a plurality of cambered protrusions.

16. The display as claimed in claim 11, wherein the light guide plate further comprises:
a third side surface, opposite to the second side surface and in contact with the light emitting surface, the bottom surface, the light incident surface and the first side surface; and
a second microstructure, formed on the third side surface and adjacent to the light incident surface.

17. The display as claimed in claim 16, wherein a position of the second microstructure corresponds to a position of the first microstructure.

18. The display as claimed in claim 16, wherein a configuration of the second microstructure is identical to a configuration of the first microstructure.

19. The display as claimed in claim 11, wherein the backlight module further comprises a second linear light source disposed adjacent to the first side surface.

20. The display as claimed in claim 11, wherein the light guide plate is a wedge type or a flat type light guide plate.
